(19) United States
(12) Patent Application Publication
(10) Pub. No.: US 2009/0011391 A1
(43) Pub. Date: Jan. 8, 2009

(54) Electromechanical relief display

(75) Inventors: Lukas Wilhelmus Van Hees, Voorburg (NL); Maarten Van Egmond, Rijnsburg (NL)

Correspondence Address: Husch Blackwell Sanders, LLP;Welsh & Katz, 120 S RIVERSIDE PLAZA, 22ND FLOOR, CHICAGO, IL, 60606, US

(73) Assignee: Optelec Development B.V., Barendrecht (NL)

(21) Appl. No.: 11/825,588

(22) Filed: Jul. 6, 2007

(30) Foreign Application Priority Data
Jul. 4, 2007 (EP) 07111715.4

(51) Int. Cl. G09B 21/00

(52) U.S. Cl. 434/114; 340/407.1

(57) ABSTRACT

An electromechanical relief display device comprising:
a frame;
at least one tactile member provided in said frame which is movable between at least a first position and a second position such that by feeling for said tactile member a user determines in which position said tactile member is;
an oblong piezoelectric flexion member which may be bent (in a bending plane) under the influence of voltages applied thereto and subsequently flex back if these voltages are removed or if voltages with and inverted polarity are applied thereto; and
   supporting means for supporting said flexion member on said frame at two opposite sides of the flexion member wherein the flexion member comprises a contact-location which is coupled to the tactile member for moving the tactile member between the first and second position by bending or flexing back the flexion member, wherein the flexion member is a bimorph flexion member wherein the supporting means comprises at least a first and second supporting member for supporting the flexion member on at least a first and second location at a first side of the two opposite sides of the flexion member respectively and at least a third supporting member for supporting the flexion member on at least a third location at a second side of the two opposite sides of the flexion member wherein the first location and the second location are separate from each other and wherein at least one of the supporting members comprises spring means for pushing this supporting member against the flexion member so that the flexion member is clamped in between the supporting members and wherein the contact-location of the flexion member is separated from the first, third and second location.

The present invention relates to an electromechanical relief display device comprising:

a frame;
at least one tactile member provided in said frame which is movable between at least a first position and a second position such that by feeling for said tactile member a user determines in which position said tactile member is;
an oblong piezoelectric flexion member which may be bent (in a bending plane) under the influence of voltages applied thereto and subsequently flex back if these voltages are removed or if voltages with and inverted polarity are applied thereto; and
supporting means for supporting said flexion member on said frame at two opposite sides of the flexion member wherein the flexion member comprises a contact-location separated from the first and second location which is coupled to the tactile member for moving the tactile member between the first and second position by bending or flexing back the flexion member.

Furthermore, the present invention relates to an electromechanical relief display device comprising:

a frame;
at least one tactile member provided in said frame which is movable between at least a first position and an second position such that by feeling for said tactile member a user determines in which position said tactile member is;
an oblong piezoelectric flexion member which may be bent (in a bending plane) under the influence of voltages applied thereto and subsequently flex back, if these voltages are removed or if voltages with and inverted polarity are applied thereto, for moving the tactile member between the first and second position; and
supporting means for supporting said flexion member on said frame, wherein the display comprises a first set of flexion members (preferably having the same length) wherein the flexion members of the first set are mounted to the frame (preferably in a stepped pattern) one above the other in a common bending plane.
Such a display is known from U.S. Pat. No. 4,758,165. Touching the device, a person can determine in which position the tactile member is. Such a known electromechanical relief display can be used as a braille cell for forming a braille character.

In the known display the contact location is usually at the end point of the flexion member so that a bending of the flexion member results in a as large as possible displacement of the corresponding tactile member. In order to make full use of the deflection of the flexion member the neutral position of the contact location must be at a desired position as accurate as possible. Hence, it is important that the flexion member is attached to the frame and aligned relative to the frame as accurate as possible in a desired manner. In order to achieve this, it is known that the flexion member is supported by the supporting means at two opposite sides of the flexion member. Furthermore, in order to adjust the flexion member at its desired direction relative to the frame, it is known to bend a conducting wire which is in fact an extension of a central conductive layer of the flexion member in such a manner that the flexion member is aligned in its desired direction within the frame. A disadvantage of such a display is that each flexion member has to be individually aligned by bending the wire. In practice an electromechanical relief display is provided with eight tactile members and eight flexion members each of which determine the position within the frame of one of the tactile members. Hence, for only one relief display, eight flexion members have to be individually adjusted. In practice, this is carried out manually meaning that it is very time consuming and relatively costly.

Furthermore, it is seen as an advantage if the oblong piezoelectric flexion member can be made relatively short. If the flexion member is shortened, this means that its bending angle should increase if the distance between the first and second position of the tactile member remains the same. If the flexion member is a bimorph flexion member, the flexion member may be shortened because a bimorph flexion member may bend over a relatively large angle. An advantage of a shortened flexion member is that the display can be manufactured in a more compact design and is thereby less space consuming. This is important as users demand increasingly portable, thus compact, devices.

However, the alignment of a flexion member becomes even more critical if the length of the flexion member is decreased.

Therefore, the present invention has one as its objects to avoid the required manually adjustment of the flexion member in the frame as discussed above.

According to one aspect of the invention, the electromechanical relief display is accordingly characterized in that the flexion member is a bimorph flexion member wherein the supporting means comprises at least a first and second supporting member for supporting the flexion member on at least a first and second location at a first side of the two opposite sides of the flexion member respectively and at least a third supporting member for supporting the flexion member on at least a third location at a second side of the two opposite sides of the flexion member wherein the first location and the second location are separate from each other and wherein at least one of the supporting members comprises spring means for pushing this supporting member against the flexion member so that the flexion member is clamped in between the supporting members and wherein the contact-location of the flexion member is separated from the first, third and second location.

Due to the spring means pushing the relevant at least one, supporting member against the flexion member, the flexion member can automatically be aligned in the desired direction relative to the frame without manually adjustments. If the display is manufactured, a flexion member is inserted between the supporting members at its desired position after which due to the spring means, the direction of the flexion member relative to the frame is automatically obtained. Preferably it holds that the supporting means comprises a fourth supporting member for supporting the flexion member at a fourth location on the second side separate from the third location. Due to the fourth supporting member a very stable fixation of the flexion member in the frame can be obtained. Furthermore these supports allow to maximise perceived stiffness of the flexion member and at the same time maximises the bending angle.

More particularly, it holds that the first supporting member and the third supporting member lay opposite each other on the opposite sides of the flexion member and that the second supporting member and the fourth supporting member lay opposite each other on the opposite sides of the flexion member wherein at least one of the first and third supporting member comprises a spring means for clamping the flexion between the first and third supporting member. In such arrangement a very stable positioning of the flexion member to the frame is obtained. Preferably it holds in that case that at least one of the second and fourth supporting members comprise a spring means for clamping the flexion between the second and fourth supporting member. In such an embodiment it is relatively easy to slide the flexion member between the supporting members during manufacturing. Preferably it holds that one of the first and third supporting members comprises opening means for damping the flexion member between the first and third supporting member wherein another of the first and third supporting members is fixed and that one of the second and fourth supporting members comprises spring means for damping the flexion member between the second and fourth supporting member wherein another of the second and fourth supporting member is fixed, the spring means allow to zero out thickness variations that are inherent to piezoelectric flexion members, for example of types which are used in Braille cells. More preferably it holds that each of the first and second supporting member comprises the spring means and each of the third and fourth supporting member is fixed or that each of the third and fourth supporting member comprises the spring means and each of the first and second supporting member is fixed. In that case both a zero out of thickness variations as well as a most accurate alignment of the flexion member in its desired direction is obtained. The alignment is automatically obtained on the bases of the fixed supporting members independent from the thickness of the flexion member. Alternatively, it holds that each of the first and third supporting member comprises a spring means for clamping the flexion between the first and third supporting member. It also preferably holds that each of the second and fourth supporting member comprises a spring means for clamping the flexion between the first and third supporting member. In that case it is most easy to insert the flexion member between the spring because each supporting member can adapt its position relative to the frame for receiving the flexion member between the support members so that sufficient space for manipulating the flexion member between the support members can be obtained during manufacturing without the risk of damaging the frame and/or the supporting means.

If the flexion member is bended by applying said voltages, it bends in a bending plane perpendicular to the opposite sides of the flexion member. Preferably it holds that each of the spring means pushes against one of the opposite sides of the flexion member in or opposite a direction wherein the flexion bends (or in a direction laying in a bending plane wherein the flexion bends) under influence of the voltages.

According to a preferred embodiment it holds that the display comprises a plurality of tactile members and a corresponding plurality of the flexion members wherein each tactile member is moved by one of the flexion members and wherein each of the flexion members are supported on said frame by the supporting means. More particularly it preferably holds in that case that each of the flexion members are supported on said frame by the supporting means in a mutual similar manner. According to a very practical embodiment for obtaining a braille cell the display is characterized in that the display comprises a first set of flexion members (preferably having the same length) wherein the flexion members of the first set are mounted to the frame (preferably in a stepped pattern) one above the other in a common bending plane. Preferably it holds that the supporting members corresponding to the first set are located relative to the frame per flexion member in the same pattern as the flexion members of the first set are located relative to the frame. According to a very advantageous embodiment it further holds that the first set comprises pairs of first and second flexion members laying adjacent and separated to each other in the bending plane wherein a first and second supporting member supporting the first side of the first flexion member and a third and fourth supporting member supporting the second side of the second flexion member are part of a single clip. Because a single clip is used, the display can be manufactured easy with a limited amount of components. According to a practical embodiment it preferably further holds that the display comprises a second set of flexion members (preferably having the same length) wherein the flexion members of the second set are mounted to the frame (preferably in a stepped pattern) one above the other in a common bending plane. Preferably it also holds for the flexion members of the second set that the supporting members corresponding to the second set are located relative to the frame per flexion member in the same pattern as the flexion members of the second set are located relative to the frame. According to a very advantageous embodiment it holds that the second set comprises pairs of first and second flexion members laying separated and adjacent to each other in the bending plane wherein a first and second supporting member supporting the first side of the first flexion member of the first set and a third and fourth supporting member supporting the second side of the second flexion member of the first set are part of a single clip. Also this embodiment has the advantage that the display can be manufactured efficiently with a minimum amount of components. It holds preferably in that case that the bending planes of the first and second set extend parallel to each other wherein the positions of the flexion members of the first set and the positions of the flexion members of the second set are shifted relative to each other in a direction perpendicular to the bending planes. In that case the display may be used for displaying a braille character.

According to a very advantageous embodiment it holds that the first flexion member of the first set and the first flexion member of the second set are shifted relative to each other in a direction perpendicular to one of the bending planes and the second flexion member of the first set and the second flexion member of the second set are shifted relative to each other in a direction perpendicular to one of the bending planes wherein a first and second supporting member supporting the first side of the first flexion member of the first set, a third and fourth supporting member supporting the second side of the second flexion member of the first set, a first and second supporting member supporting the first side of the first flexion member of the second set and a third and fourth supporting member supporting the second side of the second flexion member of the second set are part of a single clip. Hence, it that case a single clip of eight supporting members each comprising one of said springs. Hence, in that case a minimum amount of components are used and manufacturing the display is very easy because only one clip has to be placed for positioning in place eight supporting members each comprising a spring means.

A display according to the invention is preferably further characterized in that said flexion members each are at least provided with two layers of piezoelectric ceramic material and a conductive central layer wherein the conductive central layer is attached to and sandwiched between the two layers of piezoelectric ceramic material. According to a very highly preferred embodiment it holds that layers of piezoelectric ceramic material of two adjacent flexion members of the first set and the second set respectively and which face each other are conductively connected to a common voltage supply line and that layers of piezoelectric ceramic material of each flexion member of the first set and the second set are connected to different voltage supply lines. Preferably in that case the central conductive layers of each flexion member of the first and second set is connected to an individual voltage control supply line. Because the layers which form the piezoelectric ceramic material are usually outer layers of the flexion member and because these layers of adjacent flexion members which face each other are conductively connected to a common voltage supply line, the risk of short circuiting is avoided if these layers which face each other would contact each other if they are for example bended towards each other. This is different from conventional displays wherein such layers of adjacent flexion members which face each other due to because the flexion members being stacked one on top of the other, are provided with different voltages wherein two such layers belonging to one and the same flexion member are also provided with different voltages. In that case short circuiting will happen if such opposing layers contact each other. It is known to lower the risk of short circuiting by applying very thin and weak flexion members and/or to provide isolating baffles between said layers which face each other. Because according to said preferred embodiment of the invention short circuiting can not occur it is possible to use more powerful flexion members compared the flexion members used in the conventional products. This makes the flexion member feel very rigid which helps blind users to identify the individual tactile members more accurately in case the display for example is used as a Braille cell. Because no short circuit preventing baffles are needed, the Braille cell can even be made smaller without using thinner flexion members than previous models.

In case the single clip which provides eight supporting members as discussed above is manufactured from a conductive material such as a metal, it has the further advantage that the layers of piezoelectric material of two adjacent flexion members of the first set and the second set respectively and which face each other can be conductively connected to each other by means of the single spring clip. Hence, by means of a single spring clip four of such layers can be conductively connected to each other.

According to a preferred embodiment it further holds that the display is further provided with a PCB comprising a electronic circuit for supplying voltages to the layers of piezoelectric ceramic material of the flexion members wherein the central conductive layer is directly conductively connected to a voltage supply line of the PCB< without intermediate electric leads or wires. The intermediate electric lead or wire can now be avoided because it is no longer necessary as opposed to the known systems to use these leads for adjusting the direction of the flexion members within the display.

Preferably it further holds that the display is provided with rigid outer walls extending parallel to a bending plane or a bending direction of the at least one flexion member wherein the at least one flexion member may bend. It also preferably holds that each clip comprises a base body and a plurality of U-shaped leaf springs attached to the central body portion wherein each U-shaped leaf spring forms a supporting member including a spring means. In that case the single spring clips as discussed above can have a very simple design. In that case a spring clip comprises a central body portion and U-shaped leaf springs wherein each U-shape leaf spring forms a supporting member comprising a spring means.

According to another aspect of the invention, the electro mechanical relief display is characterized in that said flexion members are bimorph flexion members each being at least provided with two layers of piezoelectric ceramic material and a conductive central layer wherein the conductive central layer is attached to and sandwiched between the two layers of piezoelectric material and wherein layers of piezoelectric ceramic material of two adjacent flexion members of the first set which face each other are conductively connected to a common voltage supply line and wherein layers of piezoelectric ceramic material of each flexion member of the first set are connected to different voltage supply lines. In that case short circuiting may be prevented if adjacent flexion members which are stacked one above the other bend to each other in a way that two layers of piezoelectric ceramic material of adjacent layers contact each other because they would bend a little too much. This may happen in view of the fact that bimorph flexion members are used which have excellent mechanical and electromechanical properties.

The invention will now be discussed on the basis of the following drawings wherein:

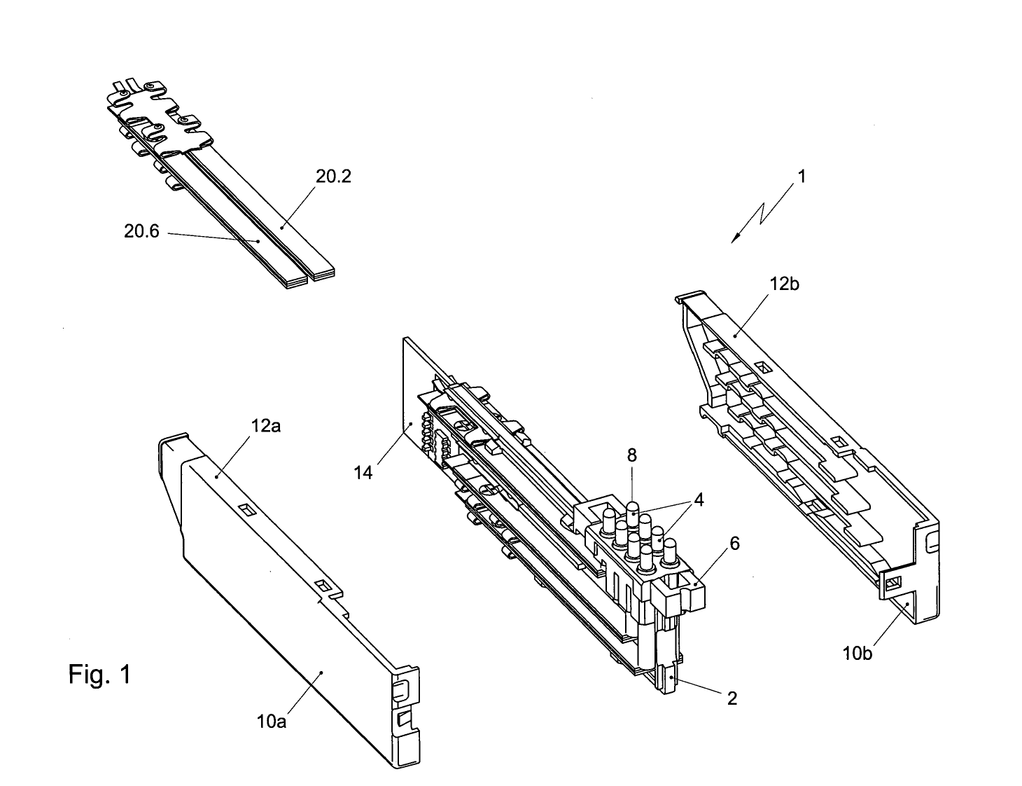

FIG. 1 shows a possible embodiment of an electromechanical relief display, taken into pieces;

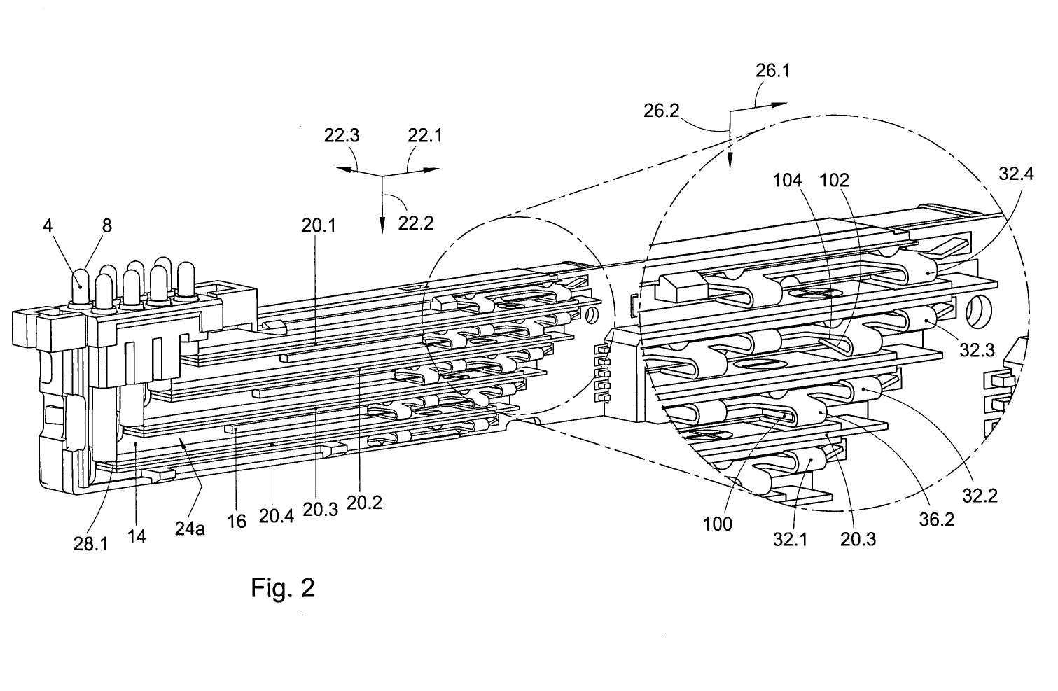

FIG. 2 shows a side view of a frame, tactile members, supporting means, flexion members and a PCB board of the display according to FIG. 1;

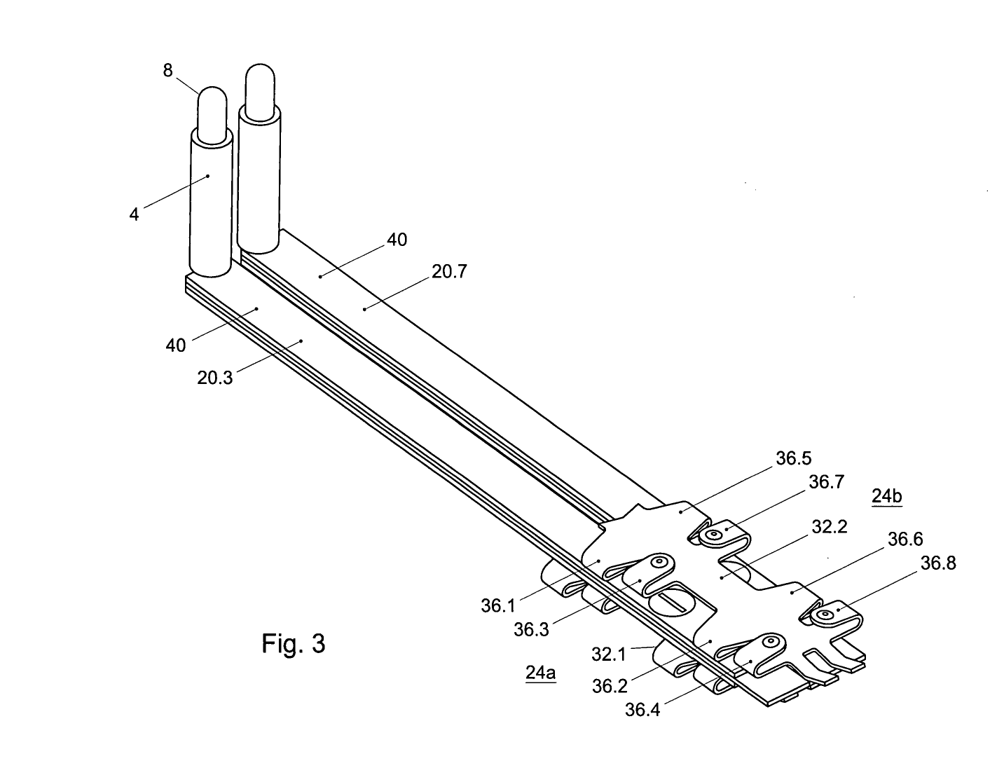

FIG. 3 shows two neighbouring flexion members and their corresponding multi spring clips of the supporting means of the display according to FIG. 1;

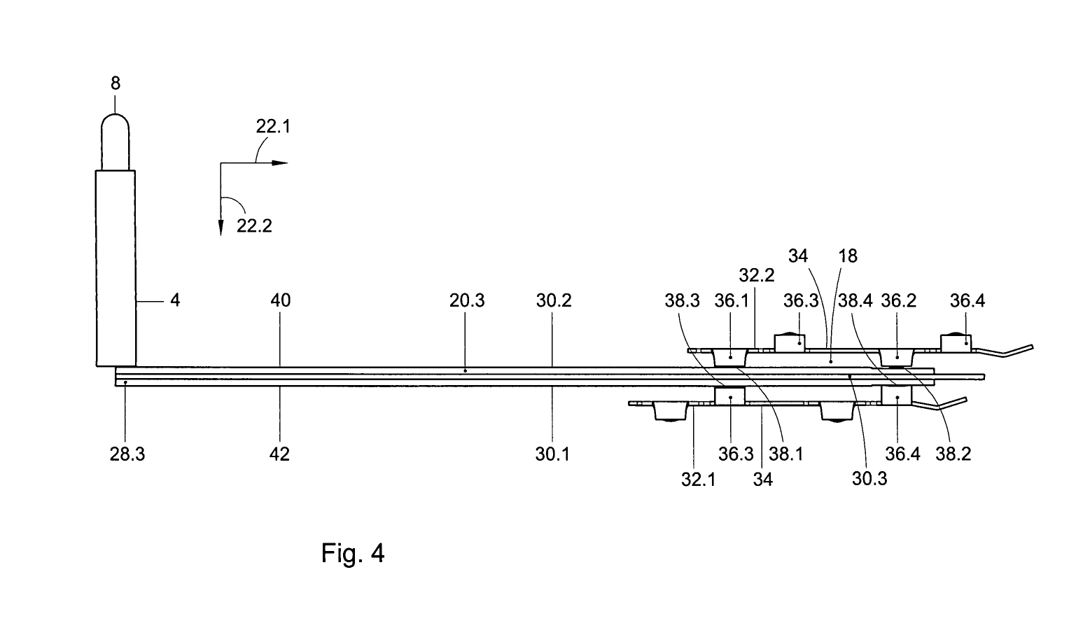

FIG. 4 shows a side view of the neighbouring flexion members and their clips as shown in FIG. 3;

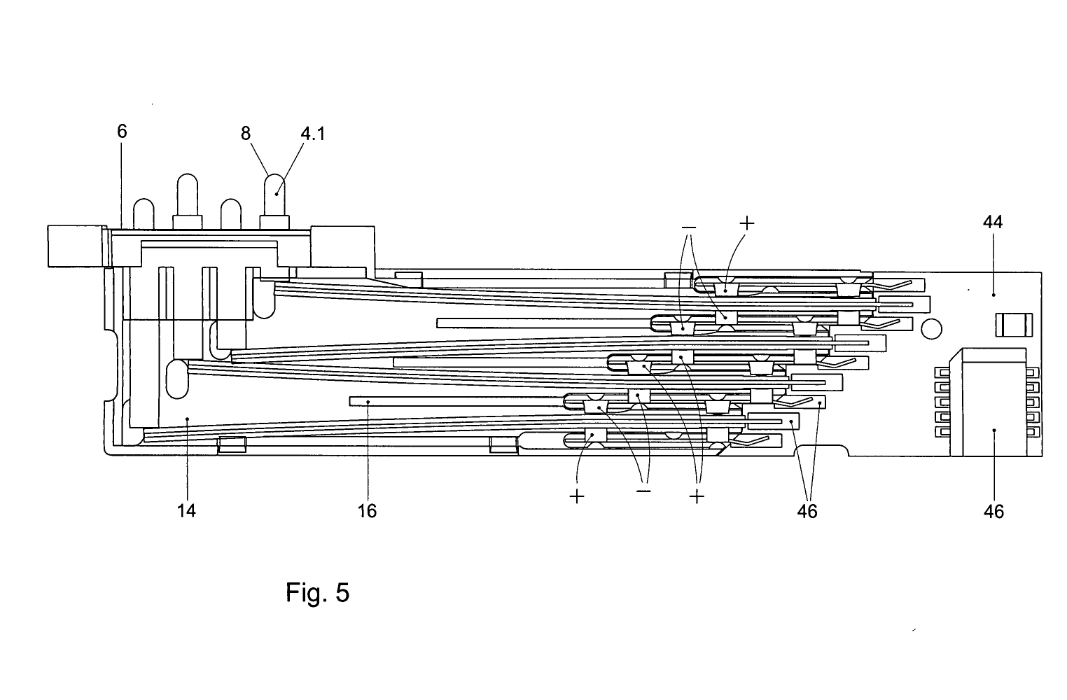

FIG. 5 shows a side view of the frame, tactile members, supporting means, flexion members and a PCB board of the display according to FIG. 1;

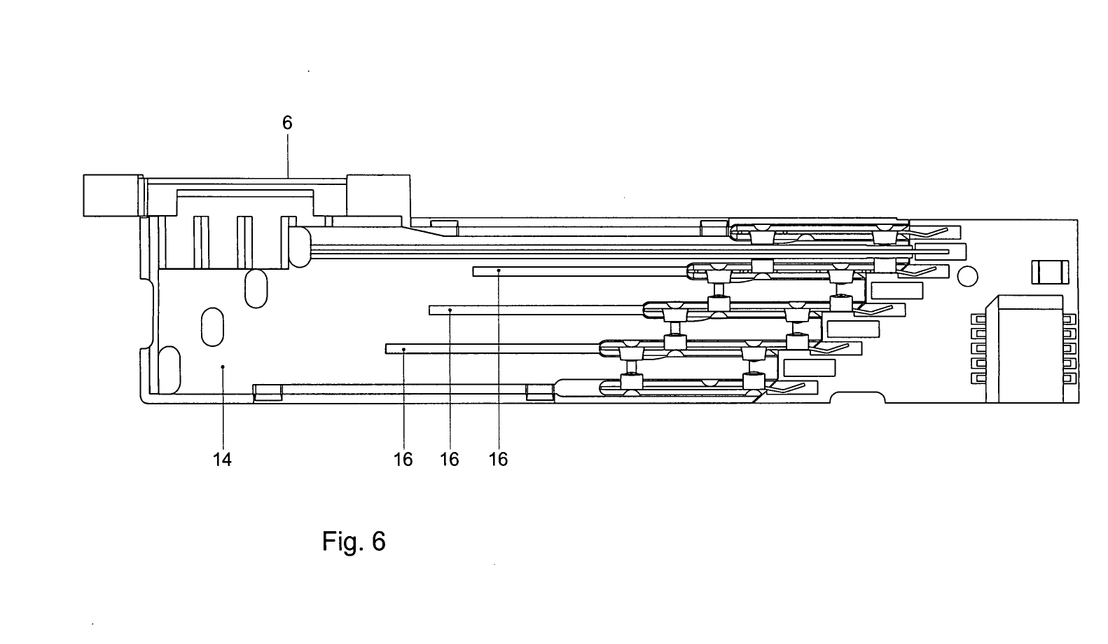

FIG. 6 shows another side view of the frame, supporting means, a single flexion member and a PCB board of the display according to FIG. 1;

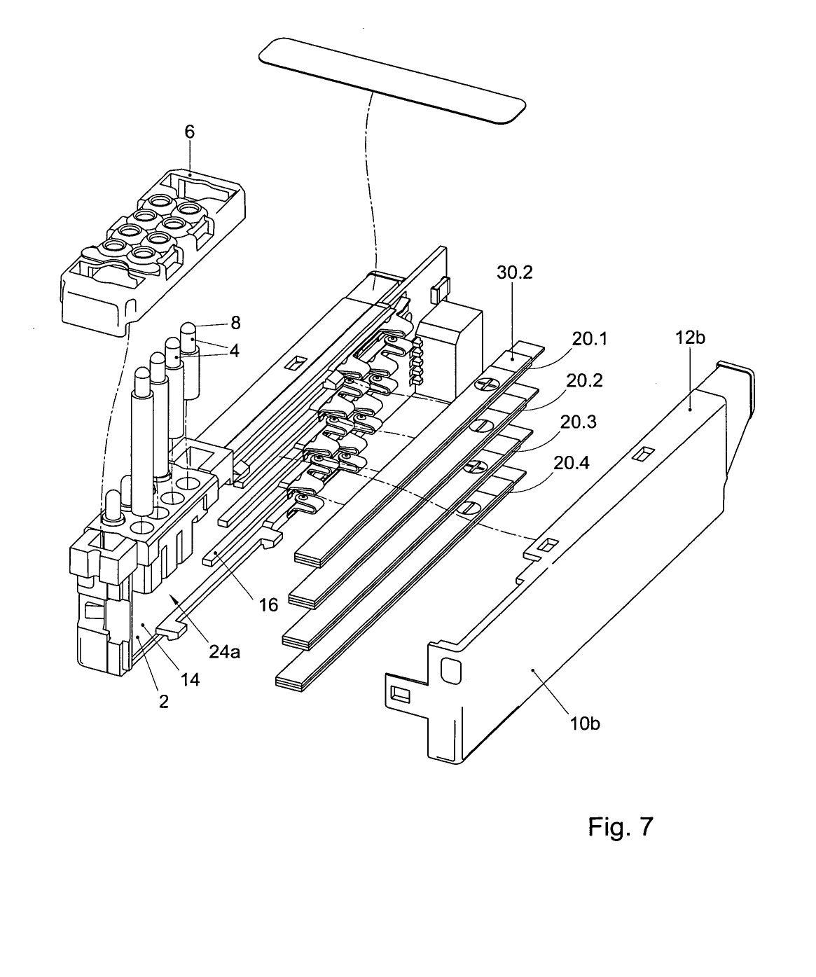

FIG. 7 shows a side view of the frame, tactile members, supporting means, some flexion members, a PCB board, an outer surface, and an outer side wall of the display according to FIG. 1; and

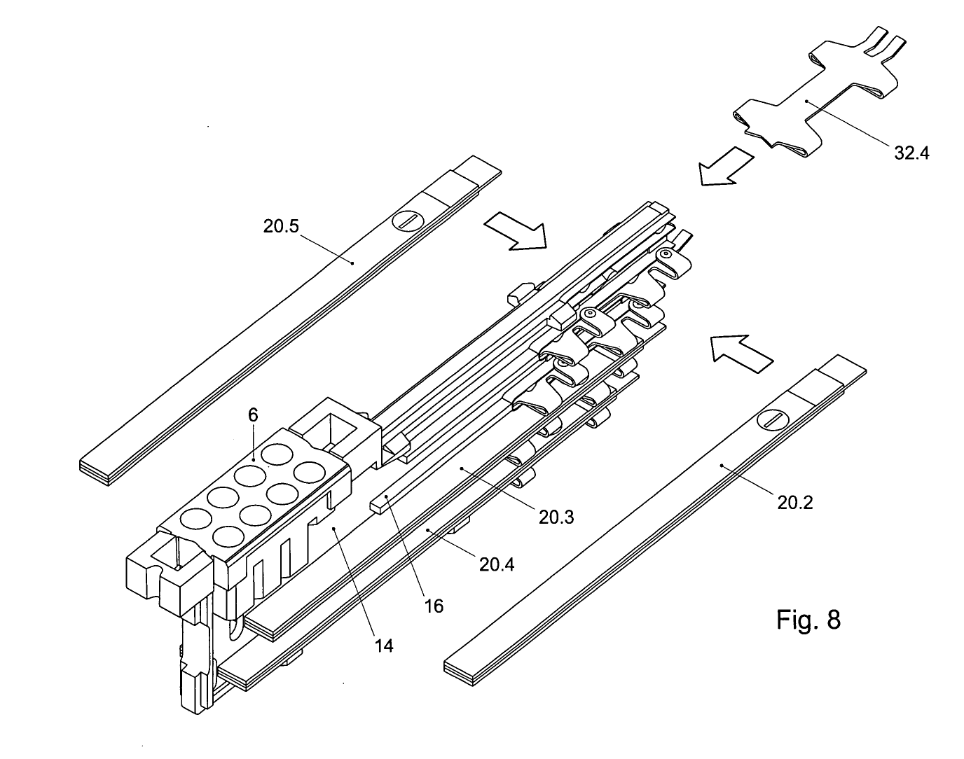

FIG. 8 shows a side view of the frame, supporting means, and some flexion members during an assembling stage.

In FIG. 1 reference number 1 indicates an electromechanical relief display according to a possible embodiment of the invention taken apart into some components. The display 1 is provided with a plastic frame 2 and a plurality of tactile members 4 provided in said frame which are each movable between at least a first position and a second position such that by feeling of said tactile members the user can determine in which position said tactile members are. The relief display comprises an upper surface wall 6 comprising a plurality of openings through which the tactile members extend. In a first position of a tactile member a top 8 of a tactile member lays at least substantially in a plane going through the outside surface of the upper wall 6. In the second position a tactile member extends out of the opening as shown in FIG. 1. In FIG. 1 the display 1 is provided with eight tactile members such that a braille cell for forming a braille character is obtained.

The relief display 1 is further provided with two rigid outside sidewalls 10a, 10b. Upper wall portions 12a and 12b are integrally formed with the sidewalls 10a, 10b.

Furthermore, in this embodiment the frame 2 is provided with a central baffle 14 which in the drawing is directed in a vertical direction. It further comprises a plurality of supporting baffles 16 attached to the central baffle 14 wherein the supporting baffle 16 extend in the drawings in a horizontal direction. The supporting baffles 16 are for supporting members 18 yet to be discussed.

The display is further provided with a plurality of oblong piezoelectric flexion members 20.1-20.8. Each flexion member may bend in a bending plane. In this example each bending plane extends in a direction parallel to the central baffle 14.

In this example the display comprises a first set of flexion members which, in the example, each have the same length wherein the flexion members of the first set are mounted to the frame in a stepped pattern one above the other in a common bonding plane 22 which is indicated in FIG. 2 by arrows 22.1 and 22.2. As shown in FIG. 2 the flexion members 20.1-20.4 form a first set of flexion members. The flexion members of the first set are stacked one above the other in a direction of the arrow 22.2. Furthermore the flexion members 20.1-20.4 of the first set are mounted to the frame in a stepped pattern. Indeed as can be seen in FIG. 2 the stepped pattern extends in a direction of the arrow 22.1 and arrow 22.2. The flexion members of the first set are each positioned on one side 24a of the central baffle. On a second side 24b of the central baffle wherein the first and second side 24a, 24b lay on different sides of the central baffle 14, a second set of flexion members 20.5-20.8 is attached to the frame in a similar manner as discussed above for the flexion members of the first set.

Hence, it also holds for the second set of flexion members that they have in this example the same length wherein the flexion members of the second set are mounted to the frame in a stepped pattern one above the other in a common bending plane 26 which is denoted in FIG. 2 by arrows 26.1 and 26.2. The bending plane 26 extends parallel to the bending plane 22. Furthermore, the central baffle 14 is sandwiched between the bending planes 22 and 26. In this example this baffle 14 prevents electrical and/or mechanical contact between flexion members laying on opposite sites of the baffle 14 respectively. It also holds that the flexion members of the second set are stacked one above the other in a direction of the arrow 26.2 and the arrow 26.1. Each flexion member comprises a contact location 28.1-28.8 which is coupled to one of the tactile members for moving the tactile member between the first and second position by bending or flexing back the flexion member. This is shown in FIG. 4 wherein the contact location of flexion member 20.3 is close to a free end of the flexion member 20.3. By bending the flexion member 20.3 while it is fixed to the frame by means of supporting means 18, yet to be discussed, wherein the bending takes place in the bending plane 22, the tactile member 4 can move in a direction of the arrow 22.1. The bending of the piezoelectric flexion member can take place under the influence of voltages supplied thereto and subsequently deflect back if the voltages are removed. This process is accelerated if (temporarily) voltages with and inverted polarity are applied to the flexion member. In that case the absolute value of the inverted voltages may be but need not be the same as the absolute value of the non-inverted voltages. The inverted voltages may be removed if the flexion member has reached its neutral position. If the inverted voltages are not removed the flexion member will continue bending passing its neutral position in a direction opposite to the direction of the arrow 22.1.

In this example each flexion member is at least provided with two layers, in this example, outer layers from piezoelectric ceramic material. These layers are denoted by reference numbers 30.1 and 30.2 in FIG. 4. Furthermore, each flexion member comprises a conductive central layer 30.3 wherein the conductive central layer 30.3 is attached to and sandwiched between the two layers of piezoelectric ceramic material 30.1 and 30.2. In the example a voltage of for example −240 V is applied to the layer 30.1 whereas a voltage of +240 V is supplied to the layer 30.2. If subsequently a voltage of +240 V is supplied to the conductive layer 30.3, the flexion member will bend such that its contact location 28 will move upwards whereas if a voltage of −240 V is supplied to the central layer 30.3, the flexion member 20.2 will bend such that its contact location 28.3 will move downwards.

In this example the tactile member 4 is in its first position if the flexion member is bent such that its contact location is moved downwards wherein the tactile member 4 is in its second position if the flexion member is bent such that its contact location 28 is moved upwards. Hence, in this example, the first and second location of the tactile members are determined by the flexion members when they are in a bent condition. If a flexion member is flexed back to a neutral position (which happens in case there is not applied a voltage to the layer 30.3) then the corresponding tactile member is in a position somewhere between the first and second position. Of course this is not essential. In an alternative embodiment the relaxed condition of a flexion member could for example correspond with the first position of the corresponding tactile member whereas a bent condition of a flexion member could correspond to the second position of the tactile member. This set-up may be a so called unimorph.

The relief display is further provided with supporting means for supporting each of said flexion members on said frame at two opposite sides of the flexion member.

The supporting means for supporting, for example, the flexion members 20.3 and 20.7 comprises a multi spring clip 32.1 and a multi spring clip 32.2 respectively. See for example FIGS. 2, 3 and 4. Clip 32.2 is provided with a central body portion 34 extending in the longitudinal direction of the flexion members.

Furthermore, clip 32.2 comprises on a first side 24a of the central body portion 34 two U-shaped leaf springs 36.1 and 36.2, which are bent nearwardly. Furthermore it comprises on the same side two U-shaped leaf springs 36.3 and 36.4 which are bent upwardly. Furthermore it comprises on the other side 24b of its central body portion 34 two leaf springs 36.5 and 36.6 which are bent nearwardly. Finally it comprises on the side 24b of the central body portion 34 two leaf springs 36.7 and 36.8 which are bent upwardly. Clip 32.2 has the same shape as clip 32.1 and therefore also comprises eight U-shaped leaf springs. The clips 32.1 and 32.2 are in this example manufactured from a metal. Furthermore, the central body portion and the leaf springs of each clip form a one-piece integrated whole. As can be seen in FIG. 2, the clips 32.1 and 32.2 are inserted in a opening in the central baffle 14 while it is further supported by means of the supporting baffles 16. The result is that for example flexion member 20.3 is clamped in its desired position and direction by means of the clips 32.1 and 32.2. More particularly, the flexion member 20.3 is clamped between the U-shaped leaf springs 36.1 and 36.2 of clip 32 and the U-shaped leaf springs 36.3 and 36.4 of clip 32.2. U-shaped leaf spring 36.1 of clip 32.2 forms in this example a first supporting member for supporting the flexion member 20.3 on a first location 38.1 laying on a first side 40 of the flexion member. Furthermore, the U-shaped leaf spring 36.2 of clip 32.2 forms a second supporting member for supporting the flexion member 20.3 on a second location 38.2 at the first side 40 of the flexion member 20.3. Furthermore, the U-shaped leaf spring 36.3 of clip 32.1 forms a third supporting member for supporting the flexion member 20.3 on a third location 38.3 at a second side 42 of the two opposite sides 42 of the flexion member 20.3. The first location and the second location are separate from each other. In this example each of the supporting members comprise a spring means for pushing the supporting members against the flexion members so that the flexion member is clamped in by means of the supporting members. Furthermore it holds that the contact location 28.3 of the flexion member is separate from the first, third and second location respectively.

The U-shaped leaf spring 36.4 of the clip 32.1 forms a fourth supporting member for supporting the flexion member 20.3 at a fourth location 38.4 on the second side 42 wherein said fourth location is separate from the third location 38.3. It further follows that with reference to the flexion member 20.3 the first supporting member 36.1 and the third supporting member 36.3 lay opposite each other on opposite sides 40,42 of the flexion member and that the second supporting member 36.2 and a fourth supporting member 36.4 lay opposite each other on opposite sides 40,42 of the flexion member wherein each of the supporting members comprise a spring means for clamping the flexion member between the first and third supporting member and between the second and fourth supporting member respectively.

The flexion member 20.7 which lays on the other side 24b of the central baffle 14 is clamped in by means of the clips 32.1 and 32.2 in a same manner as discussed above for flexion member 20.3. Hence, U-shaped leaf springs 36.5 and 36.6 of clip 32.2 and U-shaped leaf springs 36.7 and 36.8 of clip 32.1 each form a supporting member, more particular four supporting members, for clamping the flexion member 20.7 between each of said supporting members.

It is furthermore noted that the U-shaped leaf springs 36.3 and 36.4 from clip 32.2 form supporting members each comprising a spring means for supporting the flexion member 20.2 laying above the flexion member 20.3. Similarly the U-shaped leaf springs 36.7 and 36.8 of clip 32.1 form supporting members each comprising a spring means for supporting the flexion member 20.6 laying above flexion member 20.7. Hence, in this example clip 32.2 is used to support the four flexion members 20.2, 20.2, 20.6 and 20.7 respectively. The clips 32.1, 32.2 and 32.3 are stacked relative to each other according to the same patterns as to which the corresponding flexion members are stacked.

In other words, the supporting members corresponding to the first set are located relative to the frame per flexion member in the same pattern as the flexion members of the first set are located relative to the frame.

It is noted that the upper multi spring clip 32.4 only comprises four nearwardly bended leaf springs. Furthermore the lower clip 32.1 only comprises four upwardly bended leaf springs.

In view of the above it further holds that the first set comprises pairs of first and second flexion members (20.1, 20.2; 20.2, 20.3; 20.3, 20.4) laying adjacent to and separate from each other in the bending plane 22 wherein a first and second supporting member 36.1 and 36.2 supporting the first side 40 of the first flexion member 20.3 and a third and fourth supporting member 36.3 and 36.4 supporting the second side 42 of the second flexion member 20.2 are part of a single clip 32.2.

It also follows from the above that the supporting members corresponding to the second set are located relative to the frame per flexion member in the same pattern as the flexion members of the second set are located relative to the frame. It further holds that the second set comprises pairs of first and second flexion members (for example 20.6 and 20.7) laying separate and adjacent to each other in the bending plane 26 wherein a first and second supporting member 36.5 and 36.6 supporting a first side 40 of the flexion member 20.7 of the second set and a third and fourth supporting member 36.7 and 36.8 supporting the second side 42 of the second flexion member 20.6 of the second set are part of a single clip 32.2. It further holds that the bending planes 22 and 26 of the first and second set extend parallel to each other wherein a position of the flexion members of the first set and the position of the flexion members of the second set are shifted relative to each other in a direction perpendicular to the bending planes. In this example this direction is denoted by arrow 22.3 in FIG. 2.

It further holds that a first and second supporting member 36.1 and 36.2 which support a third side 40 of a first flexion member 20.3 of the first set and a first and second supporting member 36.5 and 36.6 which support a first side 40 of a first flexion member 20.7 of the second set form part of the single clip 32.2 wherein said flexion members of the first and second set are shifted relative to each other in a direction perpendicular to one of the bending planes.

Similarly it holds that a third and fourth supporting member 36.3 and 36.4 which support the second side 42 of a first flexion member 20.3 of the first set and a third and fourth supporting member 36.7 and 36.8 supporting a second side 42 of a first flexion member 20.7 of the second set form part of a single clip 32.1 wherein said first flexion members of the first and second set are shifted relative to each other in a direction perpendicular to one of the bending planes 22, 26.

It even holds in this example that the first flexion member 20.3 of the first set and a first flexion member 20.7 of the second set are shifted relative to each other in a direction perpendicular to one of the bending planes and that the second flexion member 20.2 of the first set and a second flexion member 20.6 of the second set are shifted relative to each other in a direction perpendicular to one of the bending planes wherein a first and second supporting member 36.1 and 36.2 supporting the first side 40 of the first flexion member 20.3, a third and fourth supporting member 36.3 and 36.4 supporting the second side 42 of the second flexion member 20.2 of the first set, a first and second supporting member 36.5 and 36.6 supporting the first side 40 of the first flexion member 20.7 of the second set and a third and fourth supporting member 36.7 and 36.8 supporting the second side 42 of the second flexion member 20.6 of the second set are part of a single clip 32.2.

The same properties as discussed above for clips 32.1 and 32.2 apply to similar clips.

Because of the use of the supporting members comprising a spring means, the flexion members are automatically aligned. As shown in FIG. 8 the clips 32 can be inserted into openings in the central baffle from behind the central baffle. After that the flexion members can be inserted between the U-shaped leaf springs of the clips sideways from the central baffle. After insertion of the flexion members their supporting locations 28 are automatically aligned and it is not necessary to manually adjust the direction of the flexion members. As shown in FIG. 5, flexion member 20.1 is bent upwards for moving tactile member 4.1 in its second position. Furthermore flexion member 40.2 is bent downwards for moving the tactile member 40.2 in its first position.

In this example the display is further provided with a PCB 44 comprising electronic circuitry for applying a desired voltage to the outer layer and inner layers of each of the flexion members. As shown in FIG. 5 the central layers 13.3 are directly conductively connected to voltage supply lines 46 without any intermediate leads or wires. Such wires can be omitted because they are not needed for adjusting the direction of the flexion members as discussed above.

According to another aspect of the invention, the layers of piezoelectric ceramic material of two adjacent flexion members of the first set which face each other, such as for example layer 30.2 of flexion member 20.3 and layer 30.1 of flexion member 20.2, are conductively connected to a common voltage supply line wherein the layers of piezoelectric ceramic material of each flexion member 20 of the first set are connected to different voltage supply lines. In this example, the layers 30.2 of flexion member 20.1 and 20.3 as well as the layers 30.1 of the flexion members 20.2 and 20.4 are applied to a positive voltage of 240 V. Furthermore the layers 30.1 of flexion members 20.1 and 20.3 and the layers 30.2 of flexion members 20.2 and 20.4 are applied to a negative voltage of −240 V. The same applies mutatis mutandis to the flexion members 20.5-20.8 of the second set. Hence, the layers 30.2 of the flexion members 20.5 and 20.7 of the second set as well as the layers 30.1 of the flexion members 20.6 and 20.8 of the second set are connected to a common voltage of +240 V. Furthermore, the layers 30.1 of the flexion members 20.5 and 20.7 as well as the layers 30.2 of the flexion members 20.6 and 20.8 of the second set are connected to a common voltage of −240 V. Because in the examples, for example the clip 32.3, is made from a current conducting material it can be easily realized that for example layers 30.2 of the flexion members 20.3 and 20.7 and the layers 30.1 of the flexion members 20.2 and 20.6 are conductively connected and can thereby be easily conductively connected to a common voltage. The same applies mutatis mutandis to the other layers and clips,

In this example each of the clips are connected to one of two power supply lines of the PCB wherein a first power supply line provides +240 V and another power supply line provides −240 V. Furthermore each of the inner layers 30.3 of the flexion members are individually connected to an individual voltage control supply line of the PCB so as to individually control each flexion member as discussed above.

After that the clips, tactile members, flexion members and PCB's are brought into their desired position as discussed above, the rigid side walls 12a, 12b can be applied to close the display.

The present invention is not limited to the above referred to examples.

According to a further preferred embodiment, the bend leaf springs 36.1, 36.2, 36.5 and 36.6 are fixed for obtaining a fixed first and second supporting member for the flexion member 20.3 and for obtaining a fixed first and second supporting member for the flexion member 20.7. The same applies to each of the other nearwardly bent leaf springs. Fixation of the leaf springs may be obtained by insertion of some materials 100 inside a leaf spring, see for example spring clip 36.2 in FIG. 2. The material 100 is in this example a horizontal rigid plate 100 which extends from and is fixed to the central baffle. The horizontal plate 100 and the central baffle may be integrated in one piece. Fixation of the leaf springs may also be obtained by bending the leaf springs so that a free end 102 of the leaf spring rests against an above laying portion 104 of the leaf spring (see again FIG. 2, wherein said free end 102 and portion 104 are indicated for one leaf spring). In that case the upwardly bend leaf springs such as leaf springs 36.3, 36.4, 36.7 and 36.8 are not fixed nearwardly. In this embodiment it holds that one of the first and third supporting members comprises opening means for damping the flexion member between the first and third supporting member wherein another of the first and third supporting members is fixed and that one of the second and fourth supporting members comprises spring means for damping the flexion member between the second and fourth supporting member wherein another of the second and fourth supporting member is fixed. It further holds that each of the first and second supporting member comprises the spring means and each of the third and fourth supporting member is fixed or that each of the third and fourth supporting member comprises the spring means and each of the first and second supporting member is fixed. Furthermore it holds that the fixed supporting members are obtained by U-shaped leaf springs which are fixed.

Alternatively it is also possible to fix the upwardly bend leaf springs such as leaf springs 36.3, 36.4, 36.7, 36.8 for obtaining fixed third and fourth supporting members in a similar manner as discussed above for the nearwardly bend leaf springs. In that case the nearwardly bend leaf springs are not fixed.

In the above referred to examples the flexion member is a bimorph. Also other types of flexion members are possible such as a single morph or flexion members comprising a conductive central leaf, a piezoelectric layer on both sides of the central leafs and a conductive coating on these layers. The steady state voltages are then applied to the coatings in a similar manner as discussed above for the ceramic layers whereas the control voltages are applied to the central leaf in a similar way as discussed for the central layer 30.3. The spring means may also comprise other type of spring means than leaf springs such as coil springs, resilient members such as rubber members etc.

Furthermore, the invention is not limited to a display in the form of a braille cell. The invention is not limited to the application for forming braille characters but encompasses also devices for communicating arbitrary patterns to blind or visually handicapped persons. Such modifications all fall within the scope of the pending claims.

1. An electromechanical relief display device comprising:
a frame;
at least one tactile member provided in said frame which is movable between at least a first position and a second position such that by feeling for said tactile member a user determines in which position said tactile member is;
an oblong piezoelectric flexion member which may be bent (in a bending plane) under the influence of voltages applied thereto and subsequently flex back if these voltages are removed or if voltages with and inverted polarity are applied thereto; and
supporting means for supporting said flexion member on said frame at two opposite sides of the flexion member wherein the flexion member comprises a contact-location which is coupled to the tactile member for moving the tactile member between the first and second position by bending or flexing back the flexion member, characterised in that the flexion member is a bimorph flexion member wherein the supporting means comprises at least a first and second supporting member for supporting the flexion member on at least a first and second location at a first side of the two opposite sides of the flexion member respectively and at least a third supporting member for supporting the flexion member on at least a third location at a second side of the two opposite sides of the flexion member wherein the first location and the second location are separate from each other and wherein at least one of the supporting members comprises spring means for pushing this supporting member against the flexion member so that the flexion member is clamped in between the supporting members and wherein the contact-location of the flexion member is separated from the first, third and second location.

2. A display according to claim 1, characterised in that the supporting means comprises a fourth supporting member for supporting the flexion member at a fourth location on the second side separate from the third location.

3. A display according to claim 2, characterised in that the first supporting member and the third supporting member lay opposite each other on the opposite sides of the flexion member and that the second supporting member and the fourth supporting member lay opposite each other on the opposite sides of the flexion member wherein at least one of the first and third supporting member comprises spring means for clamping the flexion between the first and third supporting member.

4. A display according to claim 3 characterised in that at least one of the second and fourth supporting member comprises spring means for clamping the flexion between the second and fourth supporting member.

5. A display according to claim 3, characterised in that each of the first and third supporting member comprises spring means for clamping the flexion between the first and third supporting member.

6. A display according to claim 3, characterised in that each of the second and fourth supporting member comprises spring means for clamping the flexion between the first and third supporting member.

7. A display according to claim 1, characterised in that if the flexion member is bended by applying said voltages it bends in a bending plane perpendicular to the opposite sides of the flexion member.

8. A display according to claim 4, characterized in that one of the first and third supporting members comprises opening means for damping the flexion member between the first and third supporting member wherein another of the first and third supporting members is fixed and that one of the second and fourth supporting members comprises spring means for damping the flexion member between the second and fourth supporting member wherein another of the second and fourth supporting member is fixed.

9. A display according to claim 8, characterized in that each of the first and second supporting member comprises the spring means and each of the third and fourth supporting member is fixed or that each of the third and fourth supporting member comprises the spring means and each of the first and second supporting member is fixed.

10. A display according to claim 1, characterised in that each of the spring means pushes against one of the opposite sides of the flexion member in a direction in which the flexion bends or opposite the direction in which the flexion bends (or in a direction laying in a bending plane in which the flexion bends) under influence of the voltages.

11. A display according to claim 1, characterised in that it comprises a plurality of tactile members and a corresponding plurality of the flexion members wherein each tactile member is moved by one of the flexion members and wherein each of the flexion members are supported on said frame by the supporting means.

12. A display according to claim 11, characterised in that wherein each of the flexion members are supported on said frame by the supporting means in a mutual similar manner.

13. A display according to claim 11, characterised in that the display comprises a first set of flexion members (preferably having the same length) wherein the flexion members of the first set are mounted to the frame (preferably in a stepped pattern) one above the other in a common bending plane.

14. A display according to claim 13, characterised in that the flexion members of the first set have the same length wherein the flexion members of the first set are mounted to the frame in a stepped pattern one above the other in the common bending plane.

15. A display according to claim 12,
characterised in that the display comprises a first set of flexion members (preferably having the same length) wherein the flexion members of the first set are mounted to the frame (preferably in a stepped pattern) one above the other in a common bending plane; and
characterised in that the supporting members corresponding to the first set are located relative to the frame per flexion member in the same pattern as the flexion members of the first set are located relative to the frame.

16. A display according to claim 15,
characterised in that the supporting means comprises a fourth supporting member for supporting the flexion member at a fourth location on the second side separate from the third location; and
characterised in that the first set comprises pairs of first and second flexion members laying adjacent and separated to each other in the bending plane wherein a first and second supporting member supporting the first side of the first flexion member and a third and fourth supporting member supporting the second side of the second flexion member are part of a single clip.

17. A display according to claim 13, characterised in that that the display comprises a second set of flexion members (preferably having the same length) wherein the flexion members of the second set are mounted to the frame (preferably in a stepped pattern) one above the other in a common bending plane.

18. A display according to claim 17, characterised in that the flexion members of the second set have the same length wherein the flexion members of the second set are mounted to the frame in a stepped pattern one above the other in the common bending plane.

19. A display according to claim 17,
characterised in that wherein each of the flexion members are supported on said frame by the supporting means in a mutual similar manner; and
characterised in that the supporting members corresponding to the second set are located relative to the frame per flexion member in the same pattern as the flexion members of the second set are located relative to the frame.

20. A display according to claim 19,
characterised in that the supporting means comprises a fourth supporting member for supporting the flexion member at a fourth location on the second side separate from the third location; and
characterised in that the second set comprises pairs of first and second flexion members laying separated and adjacent to each other in the bending plane wherein a first and second supporting member supporting the first side of the first flexion member of the second set and a third and fourth supporting member supporting the second side of the second flexion member of the second set are part of a single clip.

21. A display according to claim 17, characterised in that the bending planes of the first and second set extend parallel to each other wherein the positions of the flexion members of the first set and the positions of the flexion members of the second set are shifted relative to each other in a direction perpendicular to the bending planes.

22. A display according to claim 21, characterised in that a first and second supporting member which support a first side of a first flexion member of the first set and a first an second supporting member which support a first site of a first flexion member of the second set form part of a single clip wherein said first flexion members of the first and second set are shifted relative to each other in a direction perpendicular to one of the bending planes.

23. A display according to claim 21, characterised in that a third and fourth supporting member which support a second side of a first flexion member of the first set and a third and fourth supporting member supporting a second side of a first flexion member of the second set form part of a single clip wherein said first flexion members of the first and second set are shifted relative to each other in a direction perpendicular to one of the bending planes.

24. A display according to claim 20,
characterised in that the supporting members corresponding to the first set are located relative to the frame per flexion member in the same pattern as the flexion members of the first set are located relative to the frame:
characterised in that the first set comprises pairs of first and second flexion members laying adjacent and separated to each other in the bending plane wherein a first and second supporting member supporting the first side of the first flexion member and a third and fourth supporting member supporting the second side of the second flexion member are part of a single clip;
characterised in that the bending planes of the first and second set extend parallel to each other wherein the positions of the flexion members of the first set and the positions of the flexion members of the second set are shifted relative to each other in a direction perpendicular to the bending planes; and
characterised in that the first flexion member of the first set and the first flexion member of the second set are shifted relative to each other in a direction perpendicular to one of the bending planes and the second flexion member of the first set and the second flexion member of the second set are shifted relative to each other in a direction perpendicular to one of the bending planes wherein a first and second supporting member supporting the first side of the first flexion member of the first set, a third and fourth supporting member supporting the second side of the second flexion member of the first set, a first and second supporting member supporting the first side of the first flexion member of the second set and a third and fourth supporting member supporting the second side of the second flexion member of the second set are part of a single clip.

25. A display according to claim 17, characterised in that the frame comprises central baffle extending between the first and second set of flexion members.

26. A display according to claim 1, characterised in that the frame comprised a plurality of support baffles supporting the supporting members wherein the supporting members are located between a support baffle and a flexion member.

27. A display according to claim 25,
characterised in that the frame comprised a plurality of support baffles supporting the supporting members wherein the supporting members are located between a support baffle and a flexion member; and
characterised in that the central baffle and the supporting baffle are integrated in a single part.

28. A display according to claim 1 wherein the frame is manufactured from a non-conductive material such as plastic.

29. A display according to claim 1 wherein the supporting means are manufactured from a conductive material.

30. A display according to claim 1, characterised in that, said flexion members each are at least provided with two layers of piezoelectric ceramic material and a conductive central layer wherein the conductive central layer is attached to and sandwiched between the two layers of piezoelectric ceramic material.

31. A display according to claim 13,
characterised in that, said flexion members each are at least provided with two layers of piezoelectric ceramic material and a conductive central layer wherein the conductive central layer is attached to and sandwiched between the two layers of piezoelectric ceramic material; and
characterised in that, the layers of piezoelectric ceramic material of two adjacent flexion members of the first set which face each other are conductively connected to a common voltage supply line and that layers of piezoelectric ceramic material of each flexion member of the first set are connected to different voltage supply lines.

32. A display according to claim 31, characterised in that the central conductive layer of each flexion member of the first set is connected to an individual voltage control supply line.

33. A display according to claims claim 17,
characterised in that, said flexion members each are at least provided with two layers of piezoelectric ceramic material and a conductive central layer wherein the conductive central layer is attached to and sandwiched between the two layers of piezoelectric ceramic material; and
characterised in that, layers of piezoelectric ceramic material of two adjacent flexion members of the second set which face each other are conductively connected to a common voltage supply line and that layers of piezoelectric ceramic material of each flexion member of the second set are connected to different voltage supply lines.

34. A display according to claim 33, characterised in that the central conductive layer of each flexion member of the second set is connected to an individual voltage control supply line.

35. A display according to claim 34,
characterised in that, the layers of piezoelectric ceramic material of two adjacent flexion members of the first set which face each other are conductively connected to a common voltage supply line and that layers of piezoelectric ceramic material of each flexion member of the first set are connected to different voltage supply lines:
characterised in that the central conductive layer of each flexion member of the first set is connected to an individual voltage control supply line; and
characterised in that layers of piezoelectric ceramic material of two adjacent flexion members of the first set and the second set respectively and which face each other are conductively connected to a common voltage supply line and that layers of piezoelectric ceramic material of each flexion member of the first set and the second set are connected to different voltage supply lines.

36. A display according to claim 30, characterised in that the display is further provided with a PCB comprising a electronic circuit for supplying voltages to the layers of piezoelectric ceramic material of the flexion members wherein the central conductive layer is directly conductively connected to a voltage supply line of the PCB without intermediate electric leads or wires.

37. A display according to claim 1, characterised in that the display is provided with rigid outer walls extending parallel to a bending plane or a bending direction of the at least one flexion member wherein the at least one flexion member may bend.

38. A display according to claim 16, characterised in that the clip is made form a conductive material such as metal.

39. A display according to claim 1, characterised in that at least one of the spring means comprises a leaf spring.

40. A display according to claim 16, characterised in that each clip comprises a central body portion and a plurality of U-shaped leaf springs attached to the central body portion wherein each U-shaped leaf spring forms a supporting member including a spring means.

41. A display according to claim 40, characterised in that the central body portion and the leaf springs of a clip form a one-piece integrated whole.

42. A display according to claim 8 or 9 and according to claim 40,
characterised in that the first supporting member and the third supporting member lay opposite each other on the opposite sides of the flexion member and that the second supporting member and the fourth supporting member lay opposite each other on the opposite sides of the flexion member wherein at least one of the first and third supporting member comprises spring means for clamping the flexion between the first and third supporting member:
characterised in that at least one of the second and fourth supporting member comprises spring means for clamping the flexion between the second and fourth supporting member:
characterized in that one of the first and third supporting members comprises opening means for damping the flexion member between the first and third supporting member wherein another of the first and third supporting members is fixed and that one of the second and fourth supporting members comprises spring means for damping the flexion member between the second and fourth supporting member wherein another of the second and fourth supporting member is fixed, and
characterized in that the fixed supporting members are obtained by U-shaped leaf springs which are fixed.

43. An electromechanical relief display device comprising:
a frame;
at least one tactile member provided in said frame which is movable between at least a first position and an second position such that by feeling for said tactile member a user determines in which position said tactile member is;
an oblong piezoelectric flexion member which may be bent (in a bending plane) under the influence of voltages applied thereto and subsequently flex back, if these voltages are removed or if voltages with and inverted polarity are applied thereto, for moving the tactile member between the first and second position; and
supporting means for supporting said flexion member on said frame, wherein the display comprises a first set of flexion members (preferably having the same length) wherein the flexion members of the first set are mounted to the frame (preferably in a stepped pattern) one above the other in a common bending plane, characterised in that said flexion members are bimorph flexion members each being at least provided with two layers of piezoelectric ceramic material and a conductive central layer wherein the conductive central layer is attached to and sandwiched between the two layers of piezoelectric material and wherein layers of piezoelectric ceramic material of two adjacent flexion members of the first set which face each other are conductively connected to a common voltage supply line and wherein layers of piezoelectric ceramic material of each flexion member of the first set are connected to different voltage supply lines.

44. A display according to claim 43, characterised in that the central conductive layer of each flexion member is connected to an individual voltage control supply line.

45. A display according to claim 43, characterised in that that the display comprises a second set of flexion members (preferably having the same length) wherein the flexion members of the second set are mounted to the frame (preferably in a stepped pattern) one above the other in a common bending plane wherein layers of piezoelectric ceramic material of two adjacent flexion members of the second set which face each other are conductively connected to a common voltage supply line and wherein layers of piezoelectric ceramic material of each flexion member of the second set are connected to different voltage supply lines.

46. A display according to claim 45, characterised in that the central conductive layer of each flexion member of the second set is connected to an individual voltage control supply line.

47. A display according to claim 46,
characterised in that the central conductive layer of each flexion member is connected to an individual voltage control supply line; and
characterised in that layers of piezoelectric ceramic material of two adjacent flexion members of the first set and the second set respectively and which face each other are conductively connected to a common voltage supply line and that layers of piezoelectric ceramic material of each flexion member of the first set and the second set are connected to different voltage supply lines.

48. A display according to claim 43, characterised in that the display is further provided with a PCB comprising a electronic circuit for supplying voltages to the layers of piezoelectric ceramic material of the flexion members wherein the central conductive layer is directly conductively connected to a voltage supply line of the PCB without intermediate electric leads.

49. A display according to claim 43, characterised in that the flexion members of the first set have the same length wherein the flexion members of the first set are mounted to the frame in a stepped pattern one above the other in the common bending plane.

50. A display according to claim 43, characterised in that the flexion members of the second set have the same length wherein the flexion members of the second set are mounted to the frame in a stepped pattern one above the other in the common bending plane.
